(19) United States
(12) Patent Application Publication
(10) Pub. No.: US 2013/0329808 A1
(43) Pub. Date: Dec. 12, 2013

(54) STREAMING PORTIONS OF A QUILTED IMAGE REPRESENTATION ALONG WITH CONTENT CONTROL DATA

(71) Applicants: Jorg-Ulrich Mohnen, West Hollywood, CA (US); Mark Beaven, Los Angeles, CA (US)

(72) Inventors: Jorg-Ulrich Mohnen, West Hollywood, CA (US); Mark Beaven, Los Angeles, CA (US)

(21) Appl. No.: 13/494,268

(22) Filed: Jun. 12, 2012

(51) Int. Cl. H04N 7/26

(52) U.S. Cl. 375/240.25; 375/240.26; 375/E07.027

(57) ABSTRACT

The present invention extends to methods, systems, and computer program products for streaming portions of a quilted image representation along with content control data. Portions of a digital asset (e.g., audio data, video data, geospatial data, etc.) along with content control data are encoded as series of graphical representations and quilted into a two dimensional image. Digital asset portions and content control data can be un-quilted from the two dimensional image and streamed to other computer systems. The streamed data can be decoded at the other computer systems. Content control data can be used at the other computer systems to make content control decisions with respect to the portions of digital assets quilted into the two dimensional image.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some computing environments, transfer of data between computer systems includes one computer system downloading digital assets (e.g., a file, song, movie, data set, etc.) from another computer system. In these computing environments, the downloading computer system can utilize the digital assets locally after downloading (e.g., opening a file, playing a song, etc.). In other computing environments, transfer of data between computer systems includes sending computer system streaming digital assets to a receiving computer system. In these other computing environments, the receiving computer system can utilize or interact with portions of digital assets as they are received (e.g., playing a portion of a movie or song).

In these and other computing environments, the transferred digital assets consume sizeable computing resources (reflected, for example, in storage space, RAM, network bandwidth, etc.). In general, the larger the digital asset the more computing resources are consumed for storage and transfer of the digital asset. As such, various mechanisms find themselves employed to facilitate more efficient use of computing resources. For example, various transformation and data compression algorithms can be used to reduce digital asset sizes.

Lossy and lossless compression methods can be used. Lossy compression algorithms provide greater compression rates at the cost of losing some amount of a digital asset during compression. In some environments, lossy compression is preferred, such as, for example, when some loss of a digital asset is acceptable or perhaps is even imperceptible to a user (e.g., song quality may be degraded but the degradation is mostly imperceptible to the human ear or as afforded via the method of playback). Lossless compression algorithms provide lesser compression rates. However, there is limited, if any, loss of a digital asset during lossless compression.

When transferring digital assets between computer systems it is also often difficult control access to the digital assets. With respect to digital assets, access control can include elements of authentication, authorization, and audit. Access control for digital assets is typically falls into one of two classes: those based on capabilities and those based on Access Control Lists (“ACLs”).

Conditional Access is the protection of content by requiring certain criteria to be met before granting access to this content. Conditional Access (CA) is the system that has traditionally been used to protect TV channels. The standards are tightly-defined and provide a method by which a digital television stream can be scrambled. The only people who can descramble, and thus watch, the picture are those with the right receiving box and valid keys. A Digital Rights Management system, however, is asset driven. The main difference between CA and DRM is that DRM is usually applied to a specific piece of content and a specific user(s).

In a capability-based model, holding an unforgettable reference or capability to an object provides access to the object (roughly analogous to how possession of your house key grants you access to your house). Access is conveyed to another party by transmitting such a capability over a secure channel. In an ACL-based model, a subject's access to an object depends on whether its identity is on a list associated with the object (roughly analogous to how authorities would check a traveler's passport, for example, when entering a country). Access is conveyed by editing the list.

Digital Rights Management (“DRM”) is an example of a capability model. DRM technologies attempt to give a creator or seller control of their digital asset after the digital asset has been given to another party, such as, a consumer. For example, DRM technologies enable content publishers to enforce their own access policies on content, like restrictions on copying or viewing. DRM techniques include restrictive license agreements, encryption, scrambling of expressive material, and embedding tags.

Digital watermarks are features of digital assets that are added during production or distribution. Watermarks can be used for different purposes including recording the copyright owner, recording the distributor, recording the distribution chain, and identifying the purchaser of the asset. Watermarks are not complete DRM mechanisms in their own right, but are used as part of a system for Digital Rights Management, such as helping provide prosecution evidence for purely legal avenues of rights management, rather than direct technological restriction.

Sometimes, metadata is included in purchased asset which records information such as the purchaser's name, account information, or email address. This information is not embedded in the played data, like a watermark, but is kept separate, but within the file or stream. As an example, metadata is used in media purchased from online application stores for DRM-free as well as DRM-restricted versions of their music or videos. This information can be included as MPEG standard metadata.

However, there are many methods to bypass DRM control of digital assets including audio and video content. One method to bypass DRM on audio files is to burn the content to an audio CD and then rip it into DRM-free files. There are also many software programs that intercept the data stream as it is decrypted out of the DRM-restricted file, and then use this data to construct a DRM-free file. Watermarks can typically be removed from digital assets.

Most, if not all, digital assets are also subject to the “analog hole”. That is, to output a digital asset a digital signal must at some point be turned into an analog signal. For example, in order for an audio player to play an audio file, the digital signal must be turned into an analog signal containing light and/or sound for the player. DRM is not capable of controlling content in analog form. Thus, a user can record or otherwise manipulate an analog signal outside the control of DRM techniques used on the corresponding digital asset. For example, a user could play a purchased audio file while using a separate program to record the sound back into the computer in a DRM-free file format.

### BRIEF SUMMARY

The present invention extends to methods, systems, and computer program products for streaming portions of a quilted image representation along with content control data. A sending computer system stages a two dimensional image. The two dimensional image quilts together one or more encoded series of graphic representations quilted to represent the content of one or more digital assets. The one or more encoded series of graphic representations is contained within one or more rows and one or more columns of the two dimensional image. Each of the one or more series of encoded graphic representations corresponds to a portion of the one or more digital assets. A least one of the one or more series of encoded graphic representations includes a portion of content control data (e.g., digital rights management data or content access data).

Conversion properties for the two dimensional image are deduced. One or more series of encoded graphic representations are streamed along with content control data to a receiving computer system. For each series of encoded graphic representations in the one or more series of encoded graphic representations, the series of encoded graphic representations is un-quilted from a row and column of two the dimensional image. For each series of encoded graphic representations in the one or more series of encoded graphic representations, the series of encoded graphic representations, along with any included content control data, is streamed onto a network for delivery to the receiving computer system.

At the receiving computer system, conversion properties for the two dimensional image are deduced. The stream of one or more series of encoded graphic representations is processed for content control (e.g., digital rights management or content access). For at least one series of encoded graphic representations in the stream of one or more series of encoded graphic representations, the series of encoded graphic representations is received from the computer network. The series of encoded graphic representations is included in the stream of series of encoded graphic representations. The series of encoded graphic representations includes a portion of content control data.

The encoded series of graphic representations is decoded. The portion of content control data is accessed from the series of encoded graphic representations. The content control data is used to make a content control decision (e.g., a digital rights management decision or content access decision) with respect to the one or more digital assets included in the two dimensional image.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates streaming portions of a quilted image representation along with content control data.

FIG. 2 illustrates a flow chart of an example method for streaming portions of a quilted image representation along with content control data.

### DETAILED DESCRIPTION

The present invention extends to methods, systems, and computer program products for streaming portions (or all) of a quilted image representation along with content control data. A sending computer system stages a two dimensional image. The two dimensional image quilts together one or more encoded series of graphic representations quilted to represent the content of one or more digital assets. The one or more encoded series of graphic representations is contained within one or more rows and one or more columns of the two dimensional image. Each of the one or more series of encoded graphic representations corresponds to a portion of the one or more digital assets. A least one of the one or more series of encoded graphic representations includes a portion of content control data (e.g., digital rights management data or content access data).

Conversion properties for the two dimensional image are deduced. One or more series of encoded graphic representations are streamed along with content control data to a receiving computer system. For each series of encoded graphic representations in the one or more series of encoded graphic representations, the series of encoded graphic representations is un-quilted from a row and column of two the dimensional image. For each series of encoded graphic representations in the one or more series of encoded graphic representations, the series of encoded graphic representations, along with any included content control data, is streamed onto a network for delivery to the receiving computer system.

At the receiving computer system, conversion properties for the two dimensional image are deduced. The stream of one or more series of encoded graphic representations is processed for content control (e.g., digital rights management or content access). For at least one series of encoded graphic representations in the stream of one or more series of encoded graphic representations, the series of encoded graphic representations is received from the computer network. The series of encoded graphic representations is included in the stream of series of encoded graphic representations. The series of encoded graphic representations includes a portion of content control data.

The encoded series of graphic representations is decoded. The portion of content control data is accessed from the series of encoded graphic representations. The content control data is used to make a content control decision (e.g., a digital rights management decision or content access decision) with respect to the one or more digital assets included in the two dimensional image.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. It can also be a local content access control.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

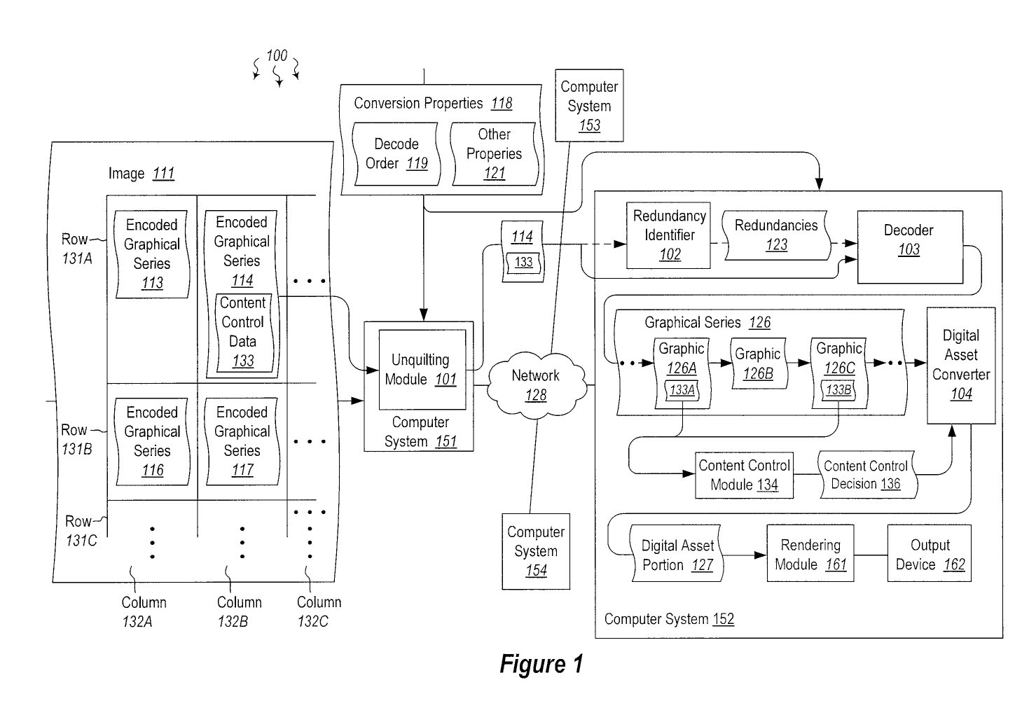

FIG. 1 illustrates an example computer architecture 100 that facilitates streaming portions of a quilted image representation along with content control data. Referring to FIG. 1, computer architecture 100 includes computer systems 151, 152, 153, and 154. Each of the depicted computer systems is connected to one another over (or is part of) network 128, such as, for example, a Local Area Network (“LAN”), a Wide Area Network (“WAN”), and even the Internet. Accordingly, each of the depicted computer systems as well as any other connected computer systems and their components, can create message related data and exchange message related data over network 128.

Data can be exchanged over network 128 using any of a variety of protocols including Internet Protocol (“IP”) datagrams and other higher layer protocols that utilize IP datagrams. Other higher layer protocols include but are not limited to: User Datagram Protocol (“UDP”), Real-time Streaming Protocol (“RTSP”), Real-time Transport Protocol (“RTP”), the Real-time Transport Control Protocol (“RTCP”), the HyperText Transfer Protocol (“HTTP”) adaptive bitrate streaming, Transmission Control Protocol (“TCP”), Unicast protocols (“UP”), Multicast protocols, IP Multicast (“IPM”), Internet Group Management Protocol (“IGMP”), Protocol Independent Multicast (“PIM”), Peer-to-peer (“P2P”) protocol, File Transfer Protocol (“FTP”), Secure Shell Protocol (“SSH”), and Secure Copy Protocol (“SCP”).

As depicted, computer system 151 (e.g., a media server) includes un-quilting module 101. In general, un-quilting module 101 is configured to un-quilt the contents of one or more rows and one or more columns of a quilted graphic 2D image representation in accordance with conversion properties. The contents of the one or more rows and one or more columns of a quilted graphic 2D image representation can include portions of digital assets and/or content control data (e.g., Digital Rights Management (“DRM”) data and/or Content (or Conditional) Access (“CA”) data). The contents of the one or more rows and one or more columns can be streamed to one or more other computer systems. At the one or more other computer systems, the contents can be rendered as a digital asset and/or used to make content control decisions.

A quilted graphic 2D image representation can include: sets of one or more one dimensional single image frames, two dimensional single image frames, a three dimension image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset, and a larger set of images quilted together to form the largest image quilt. A digital asset can be virtually any type of digital object, including but not limited to: imagery data, audio data, video data, gaming data, financial data, trading data, broadcast data, radio data, digital book data, and geo-spatial data.

Conversion properties can include a decode order for decoding the one or more series of encoded graphic representations. Conversion properties can also include image properties for a two dimensional image, having one or more rows and one or more columns, that is to store at least a sub-set of the digital asset. The image properties can include a row size that indicates the size for any rows in the two dimensional image and including a column size that indicates the size for any columns in the two dimensional image. Conversion properties can also include other properties for the two dimensional image: levels of resolution in a hierarchical data structure within quilted graphic 2D image representation, data rate frequency (e.g., ranging from 2 Hz through 256 kHz), bit depth (e.g., ranging from 2 bit through 64 bit), an indication if bit depth is variable, a number of channels (e.g., ranging from 1 channel to multispectral or hyperspectral), processing type (e.g., discreet or non-discreet processing), data type (e.g., floating point or integer), scan type (e.g., interlaced or progressive), and encoding scheme (e.g., band interleaved by part/pixel (“BIP”), band interleaved by line (“BIL”), or band sequential (“BSQ”)).

As depicted, computer system 152 includes redundancy identifier 102, decoder 103, digital asset converter 104, content control module 134, rendering module 161, and output device 162. Generally, a streamed and encoded series of graphical representations can be received over network 127.

The encoded series of graphical representations may take redundancies into account such that that there is no need to retain complete graphic representations multiple times when the same visual or audio data is represented. When appropriate, redundancy identifier 102 is configured to identify redundancies between successive graphic representations in an encoded series of graphic representations. For example, redundancy identifier 102 can identify portions of successive graphics representing the same visual data or audio data. Redundancy identifier 102 can arrange a data structure for decoding an encoded series of graphical representations into a series of graphical series that does retain complete graphic representations multiple times.

Decoder 103 is configured to decode an encoded series of graphic representations (e.g., from a row and column of a quilted graphic 2D image representation) into a decoded series of graphical representations. When appropriate, decoder 103 takes into account identified redundancies so as to restore full graphic representations. One or more graphic representations within an encoded series of graphic representations can include content control data, such as, for example, DRM data and/or CA data. Decoder 103 can preserve any content control data during decoding to make the content control data available to other modules.

Digital asset converter 104 is configured to convert a series of graphic representations into a portion of a digital asset. For example, digital asset converter 104 can convert a series of graphic representations streamed form another computer system into a set or sub-set of a digital asset (e.g., video frames, sound, game textures, imagery data, broadcast data, financial data, trading data, radio data, digital book data, or geospatial data).

Content control module 134 is configured to access content control data (e.g., DRM data and/or CA data) contained in graphical representations within a decoded series of graphical representations. Content control module 134 can make a content control decision (e.g., a DRM decision or CA decision) for one or more digital assets based on accessed content control data. For example, control module 134 can make a decision to allow access to a digital asset (or portion thereof), prevent access to a digital asset (or portion thereof), etc., based on content control data associated with the digital asset. Content control module 134 can make content control decisions available to other modules.

For example, in some embodiments, digital asset converter 104 performs digital asset conversion in accordance with the content control decisions of content control module 134. For example, if content control module 134 indicates that access to a digital asset is not authorized, digital asset converter 104 does not convert graphical series into digital asset portions for rendering. On the other hand, if content control module 134 indicates that access to a digital asset is authorized, digital asset converter 104 can convert graphical series into digital asset portions or rendering.

Rendering module 106 is configured to render portions of digital assets at output device 107. Output device 107 can be, for example, a display device and/or audio output device. Storage device 141 is configured to store portions of digital assets.

Computer systems 153 and 154 can include components similar to computer system 152 and can decode and render digital assets.

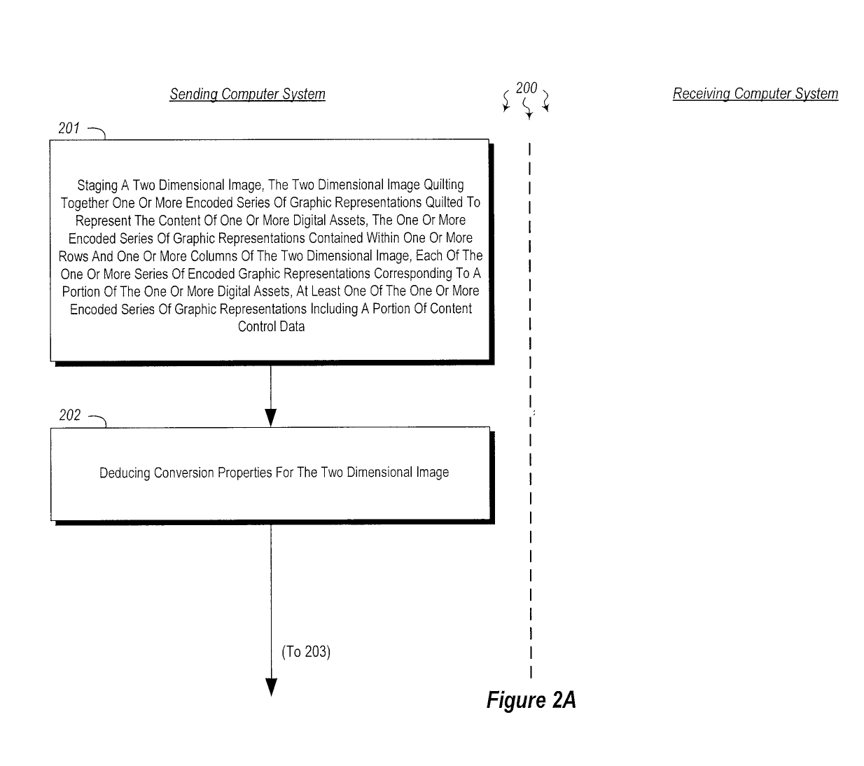

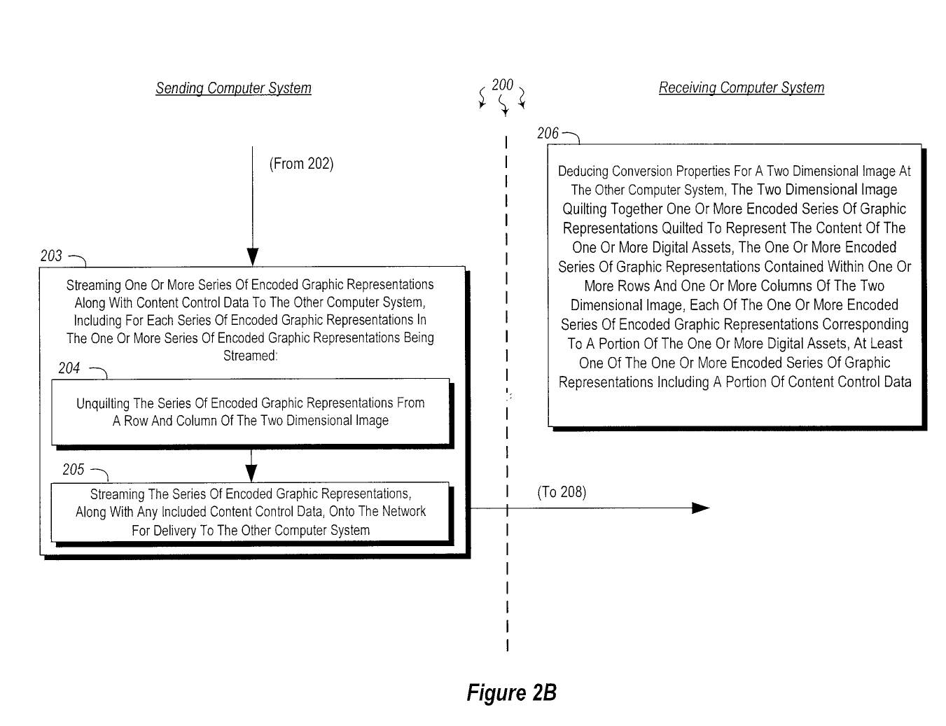

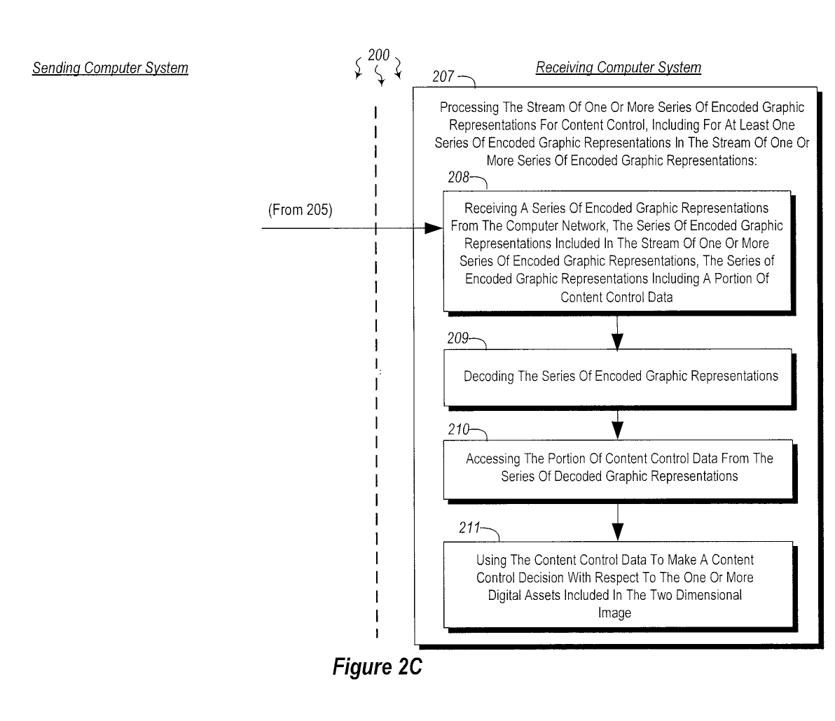

FIG. 2 illustrates a flow chart of an example method 200 for streaming portions (or all) of a quilted image representation along with content control data. Method 200 will be described with respect to the components and data of computer architecture 100.

Method 200 includes an act of staging a two dimensional image, the two dimensional image quilting together one or more encoded series of graphic representations quilted to represent the content of one or more digital assets, the one or more encoded series of graphic representations contained within one or more rows and one or more columns of the two dimensional image, each of the one or more series of encoded graphic representations corresponding to a portion the one or more digital assets, at least one of the one or more series of encoded graphic representations including a portion of content control data (act 201).

For example, computer system 151 can stage image 111. Image 111 can be a quilted graphic 2D image representation quilting together encoded graphical series in rows and columns to represent the content of one or more digital assets. For example, row 131A/column 132A stores encoded graphical series 113, row 131A/column 132B stores encoded graphical series 114, row 131B/column 132A stores encoded graphical series 116, row 131B/column 132B stores encoded graphical series 117. Other encoded graphical series can be stored in other rows and columns, such as, for example, in row 131C, column 132C, etc.

As depicted, encoded graphical series 114 contains content control data 133. Content control data 133 can include DRM data and/or CA data and can be distributed across a plurality of different graphic representations included in encoded graphics series 114. Other graphical series within image 111 can also contain content control, such as, for example, DRM data and/or CA data.

One or more digital assets quilted into a quilted graphic 2D image representation can include one or more different types of data including but not limited to: imagery data, audio data, video data, gaming data, broadcast data, radio data, digital book data, and geo-spatial data. In some embodiments, a quilted graphic 2D image representation quilts together data of a single data type. In other embodiments, a quilted graphic 2D image representation quilts together data of a plurality of different data types. For example, a quilted graphic 2D image representation for a digital asset used by a navigation system can quilt together audio data, video data, image data, and geo-spatial data.

Image 111 can include any of: sets of one or more one dimensional single image frames, two dimensional single image frames, a three dimensional image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset (i.e., digital vinyl), a larger set of images quilted together to form the largest image quilt, etc.

In some embodiments, to conserve computing resources, each of the encoded graphic representations in image 111 can be encoded taking into account redundancies between successive graphic representations within the encoded graphical series so as to reduce the size of image 111. During encoding, redundancies can be identified between portions of successive graphics representing the same visual and/or audio data such that there is no need retain the portions of successive graphics multiple times. For example, redundancies between successive graphic representations within encoded graphical series 113 can be utilized to reduce the size of encoded graphical series 113.

A series of graphic representations can also be encoded into a quilted graphic 2D image representation taking into account multiple levels of resolution within the series of graphic representations. For example, encoded graphical series 113 can be encoded into image 111 taking into account multiple levels of resolution within encoded graphical series 113.

Method 200 includes an act of deducing conversion properties for the two dimensional (act 202). For example, un-quilting module 101 can deduce conversion properties 118, including decode order 119 and other properties 121. Decode order 119 indicates an order for decoding encoded graphical series 113, 114, 116, 117, etc. Other properties 121 can include image properties for image 111. Collectively, encoded graphical series 113, 114, 116, 117 can represent one or more digital assets, such as, for example, a song, a digital book, etc.

Method 200 includes an act of streaming one or more series of encoded graphic representations along with content control data to the other computer system (act 203). For example, computer system 151 can stream encoded graphical series 113, 114, 116, 117, etc. along with content control data to computer system 152. As depicted, encoded graphical series 114 includes content control data 133. Computer system 151 can stream encoded graphical series 114 along with content control data 133 to computer system 152.

For each series of encoded graphic representations in the one or more series of encoded graphic representations being streamed, act 203 includes an act of un-quilting the series of encoded graphic representations from a row and column of the two dimensional image (act 204). For example, un-quilting module 101 can un-quilt encoded graphical series 114, including content control data 133, from row131A/column 132B of image 111.

For each series of encoded graphic representations in the one or more series of encoded graphic representations being streamed, act 203 includes an act of streaming the series of encoded graphic representations, along with any included content control data, onto the network for delivery to the other computer system (act 205). For example, un-quilting module 101 can stream encoded graphical series 114, including content control data 133, onto network 128 for deliver to computer system 152.

Acts 204 and 205 can be repeated for encoded graphical series 113, 116, and 117.

Un-quilting module 101 can also stream encoded graphical series 113, 114, 116, and 117 (as well as other parts of image 111) along with included content control data to other computer systems, such as, for example, computer system 153 and/or computer system 154.

Method 200 includes an act of deducing conversion properties for the two dimensional image at the other computer system (act 206). For example, computer system 152 can deduce conversion properties 118, including decode order 119 and other properties 121, for image 111.

Method 200 includes an act of processing the stream of one or more series of encoded graphic representations for content control (act 207). For example, computer system 152 can receive a stream of encoded graphic series including encoded graphical series 114 (and potentially also encoded graphical series 113, 116, 117, etc.) from computer system 151. Computer system 152 can process encoded graphical series 114 (and potentially also encoded graphical series 113, 116, 117, etc.) for content control.

For at least one series of encoded graphic representations in the stream of one or more series of encoded graphic representations, act 207 includes an act of receiving a series of encoded graphic representations from the computer network, the series of encoded graphic representations included in the stream of series of encoded graphic representations, the series of encoded graphic representations including a portion of content control data (act 208). For example, computer system 152 can receive encoded graphical series 114 and included content control data 133. Encoded graphical series 114 can be included in a stream that also includes encoded graphical series 113, 116, and 117.

For at least one series of encoded graphic representations in the stream of one or more series of encoded graphic representations, act 207 includes an act of decoding the encoded series of graphic representations (act 209). For example, decoder 103 can decode encoded graphical series 114 into graphical series 126, including graphic 126A, 126B, 126C, etc. As depicted, graphic 126A contains content control data portion 133A and graphic 126C contains content control data portion 133B. Upon accessing an encoded graphical image, decoder 103 can identify the source material digital asset as one or more of: imagery data, audio data, video data, gaming data, broadcast data, radio data, digital book data, or geo-spatial data.

In some embodiments, redundancy identifier 102 can identify redundancies 123 within encoded graphical series 114. In these embodiments, decoder 103 can take into account redundancies 123 so as to restore full graphics 126A, 126B, 126C, etc.

Decoding can include identifying different embedded image resolutions within a quilted graphic 2D image representation, depending on transmission and viewing/listening capabilities desired during the decoding process. For example, decoder 103 can identify different image resolutions for encoded graphical series 114 within image 111. One of the different image resolutions can be selected, for example, depending on transmission and/or viewing/listening capabilities associated with output device 107. Decoder 103 can convert encoded series 114 into graphical series 126 at the selected image resolution.

For at least one series of encoded graphic representations in the stream of one or more series of encoded graphic representations, act 207 includes an act of accessing the portion of content control data from the series of encoded graphic representations (act 211). For example, content control module 134 can access content control data portions 133A and 133B from within graphics 126A and 126C respectively. Content control module 134 can access other portions of content control data from within graphical series 126 and/or from within other graphical series decoded by decoder 103.

For at least one series of encoded graphic representations in the stream of one or more series of encoded graphic representations, act 207 includes an act of using the content control data to make a content control decision with respect to the one or more digital assets included in the two dimensional image (act 212). For example, content control module 134 can use content control data portions 133A and 133B to make a content control decision 136 with respect to one or more digital assets included in image 111. Content control decisions can be made available to other modules included in or external to computer architecture 100.

In some embodiments, content control decision 136 is sent to digital asset converter 104. Digital asset converter 104 can refer to content control decision 136 to determine how to handle (e.g., render, don't render, report on, track, etc.) digital asset portion 127.

When rendering is appropriate, digital asset converter 104 can convert graphical series 126 into digital asset portion 127 in accordance with conversion properties 118 (including a selected resolution). Rendering module 106 can then render digital asset portion 127 at output device 107 (e.g., a video and/or audio output device). Alternately and/or in combination, digital asset portion 127 can be stored at a storage device.

As described, decoding a series of encoded graphic representations from a row and column of a quilted graphic 2D image representation can take into account the identified redundancies and levels of resolution contained within a quilted graphic 2D image representation. The quilted graphic 2D image representation is decoded into a string of values (imagery, audio, video, gaming, broadcast, digital book, radio, geo-spatial). For example, a quilted graphic 2D image representation is decoded into representation elements. The string of values can be computed from the image representation elements. The string of values is restored using any of variety of transfer functions. Once processed, the string of values is defined by an output format.

As appropriate, decoder 103 and/or digital asset converter 104 can adjust to account for different data types represented in image 111.

Acts 208, 209, 210, 211, and 212 can be repeated for other encoded graphical series included in image 111, such as, for example, encoded graphical series 113, 116, and 117. Thus, additional portions of digital assets and content control data (e.g., DRM data and/or CA data) from image 111 can be streamed to computer system 152 (as well as other computer systems, such as, for example, commuter systems 153 and 154). The additional portions of content control data can be used either alternatively or in combination with content control data 133 to determine how to handle the other portions of digital assets from image 111.

As such, in some embodiments, a computer system sends a stream of encoded graphical series un-quilted from a two dimensional image. The stream of encoded graphical series represents one or more digital assets. For example, un-quilting module 101 can un-quilt rows 131A-131C and columns 132A-132C representing digital asset portion 127 as well as quilting other rows/columns into additional digital asset portions. The un-quilted rows 131A-131C and columns 132A-132C can be streamed to other computer systems. Each digital asset portion can be a portion of one or more of different types of data including but not limited to: imagery data, audio data, video data, gaming data, financial data, trading data, broadcast data, radio data, digital book data, and geo-spatial data.

One or more other computer systems receive the stream of encoded graphical series. The one or more other computer systems decode encoded graphical series into graphic representations and content control data (e.g., DRM data and/or CA data) from the rows/columns of the 2D graphic representation (e.g., image 111) based on a decoding order (e.g., decoding order 119). The receiving computer system can account for redundancies, decode, and convert each encoded graphic series to a portion of a digital asset and when appropriate content control data. The computer system can also perform content control (e.g., DRM or and/or CA) checks to determine if the portion of the digital asset can be rendered. If rendering is appropriate, the computer system can render the portion of the digital asset.

Alternately, in other embodiments, a computer system decodes a plurality of (streamed) smaller 2D graphic representations representing the content of a larger 2D graphic representation along with content control data. The computer system converts the plurality of smaller 2D graphic representations into one or more encoded graphic series (representing a digital asset) from rows/columns of the smaller 2D graphic representations based on a decoding order (e.g., decoding order 119). The computer system can account for redundancies, decode, and convert each encoded graphic series to a portion of a digital asset and when appropriate content control data. The computer system can also perform content control (e.g., DRM or and/or CA) checks to determine if the portion of the digital asset can be rendered. If rendering is appropriate, the computer system can then render the portion of the digital asset.

During decoding and/or un-quilting of a quilted graphic 2D image representations, original encoding conversion properties can be maintained/retained, including levels of resolution in a hierarchy data structure within a quilted graphic 2D image representation, data rate frequency (ranging from 2 Hz through 256 kHz), bit depth (ranging from 2 bit through 64 bit), variable bit depth, any number of channels from 1 channel to multispectral or hyperspectral, discreet or non-discreet processing, number of rows, number of columns, floating point or integer, interlaced or progressive, band interleaved by part/pixel (BIP), band interleaved by line (BIL), band sequential (BSQ).

A quilted graphic 2D image representation can be encoded to include multiple resolutions. Essentially any number of resolution levels can be used. For example, there may be 15 levels of resolution for a larger video file, or perhaps only 2 or 3 levels of resolution for a smaller audio file.

For video, different resolution levels can correspond to the format (e.g., of a movie) going from 1080p to 1080i to 720p etc. Each of these different resolution levels can be quilted (along with content control data) into a quilted graphic 2D image representation together during encoding of video.

For audio, sample frequency is an approximate parallel. For example, a two dimensional image for a portion of audio may be 5000 pixel wide by 40000 pixel long or 200,000,000 pixels. Each pixel can be viewed as a sample. If the portion of audio was 7 minutes long, that would be 420 seconds. Thus, within a quilted graphic 2D image representation there is approximately 476,190.48 (200,000,000/420) samples per second of the portion of audio. As samples/second this can be represented by 476,190 Hz or roughly 476 KHz.

Practically, the highest “resolution” detail can be 128 KHz. From there, lower and lower “resolutions” 64 KHz, 32 KHz, etc., down to 2 Hz. In other environments, 44.1 KHz may be the highest resolution and then the next lower resolution which is 22.05 KHz. Each of these different resolution levels can be quilted together (along with content control data) into a single quilted graphic 2D image representation or into a plurality of quilted 2D image representations during encoding of the portion of audio.

Devices can request that a quilted graphic 2D image representation supply digital asset data (audio, video, etc.) at a specified resolution that is at or below the highest resolution quilted into the quilted graphic 2D image representation. 15 resolution states may be quilted into a quilted graphic 2D image representation a digital asset of video data. 15 is the highest resolution (e.g., full 4K) and 1 is the lowest resolution. A device with a lower screen resolution (e.g., a mobile phone or tablet) can “ask the file” to supply it with a resolution state of “5” out of “15”. A device with higher screen resolution (e.g., a workstation editing machine) can request resolution state “15”.

Similarly, 3 resolution states may be quilted into a quilted graphic 2D image representation representing a digital asset of audio data. 3 is the highest resolution (e.g., 96 KHz) and 1 is the lowest resolution (e.g., 22.05 KHz). A device attached to a limited bandwidth network might not want to stream an audio data at a full resolution of “3”. Instead, the device can request a lower resolution, possibly “1”.

By taking redundancies between successive graphic image representations into account, embodiments of the invention can reduce resource consumption when storing digital assets in quilted graphic 2D image representations. A digital asset can be recreated at a desired resolution by un-quilting a quilted graphic 2D image representation (or portion there). Thus, a digital asset can be stored in a format that conserves computing resources and the digital asset remains available for rendering at a variety of different resolutions from a single source quilted graphic 2D image representation.

For example, a resulting lossless quilted graphic 2D image representation of raw audio data can consume approximately ⅛th the resources as the raw audio data itself. As such, the two dimensional image can be un-quilted to access the raw audio data during play back. Lossy reductions can facilitate even more significant resource savings. For example, a lossy quilted graphic 2D image representation of raw video data (e.g., a movie) can consume approximately 1/200th the resources as the raw video data itself. As such, the two dimensional image can be un-quilted to access an approximation of the raw video data during play back.

In some embodiments, a computer system that generates a two dimensional image (e.g., image 111) is configured to introduce parts of graphical representations (e.g., graphics 126A and 126C) with content control data (e.g., content control data 133), such as, for example, DRM data and/or CA data. A computer system can be configured to introduce part of a graphical representation with content control data, or can be configured holistically to introduce the whole of a graphical representation with content control data. Introduction of content control data can be in accordance with the principles of stenography (a form of security through obscurity).

That is, a computer system can introduce content control data into a graphical representation such that it is difficult for anyone without prior knowledge (e.g., anyone besides the sender and intended recipient, such as, for example, a user of computer architecture 100) to detect (or even suspect) that content control data is included in the graphical representation. Alternately or in combination, a computer system can be configured to hide content control data in a graphical representation such that content control data does not attract attention. For example, DRM data and/or CA data can be embedded into part of graphical representation corresponding to inaudible and/or non-visible portions of audio/video digital assets.

Content control data can be formulated from properties of an operating environment. For example, a module within a computer architecture where content control data is generated can access properties of the operating environment for the computer architecture, such as, for example, user information, IP addresses, CPU serial numbers, driver identifiers, mainboard serial number, information hidden/contained in RAM, etc. The module can then formulate content control data, including DRM data and/or CA data, from the accessed properties. The formulated content control data can be streamed to other computer systems.

When streamed content control data is based on properties of an operating environment, content control module 134 can process the content control data to derive the operating environment properties used to generate the content control data. For example, from a portion of content control, content control module 134 can derive the IP address, CPU serial number, mainboard serial number, etc. of the operating environment where the content control data was generated. Content control module 134 can use derived operating environment properties when making content control (e.g., DRM and/or CA) decisions.

In some embodiments, a digital asset is geotagged. For example, image 111 can be tagged geospatially with fixed coordinates (e.g., included in embedded content control data 133). As part of geospatial tagging, an origin date and origin location of image 111 can be included in image 111 as part of stenographic material. The geospatial information allows image 111 to be tracked, such as, for example, as it passes through network devices on network 128. For example, routers, switches, hubs, and computer systems on network 128 can track image 111 (a content control embedded asset) or portions thereof as it/they traverse(s) the Internet.

In geotagging and other embodiments, embedded content control data (e.g., DRM data and/or CA data) can be un-quilted and streamed from an image, without having to un-quilt and stream an entire image or even an entire encoded graphical series that contains the content control data. A content control module (e.g, at a different computer system) can then make content control decisions with respect to digital assets based on the un-quilted and streamed content control data. For example, a router can relay the location of digital asset to other computer systems based on content control data within a two dimensional image representing the digital asset (and without having to fully decode the two dimensional image).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a computer-implemented method for streaming portions of a quilted image representation along with content control data, the method comprising:
an act of staging a two dimensional image, the two dimensional image quilting together one or more encoded series of graphic representations quilted to represent the content of one or more digital assets, the one or more encoded series of graphic representations contained within one or more rows and one or more columns of the two dimensional image, each of the one or more series of encoded graphic representations corresponding to a portion the one or more digital assets, at least one of the one or more series of encoded graphic representations including a portion of content control data;
an act of deducing conversion properties for the two dimensional image;
an act of streaming one or more series of encoded graphic representations along with content control data to the other computer system, including for each series of encoded graphic representations in the one or more series of encoded graphic representations being streamed:
an act of un-quilting the series of encoded graphic representations from a row and column of the two dimensional image; and
an act of streaming the series of encoded graphic representations, along with any included content control data, onto the network for delivery to the other computer system.

2. The method as recited in claim 1, wherein the act of staging a two dimensional image comprises an act of staging a quilted graphic 2D image representation that includes one of: sets of one or more one dimensional single image frames, two dimensional single image frames, a three dimensional image set, a two dimensional image and/or Lidar set, a two dimensional image and/or point cloud set, or a film strip set.

3. The method as recited in claim 1, wherein the act of staging a two dimensional image comprises an act of staging a quilted graphic 2D image representation that has multiple levels of resolution and content control data for the one or more digital assets embedded within the quilted graphic 2D image representation.

4. The method as recited in claim 3, wherein act of deducing conversion properties for the two dimensional image comprises an act of deducing one or more of: a resolution for the one or more digital assets, the resolution from among the multiple levels of resolution embedded within the quilted graphic 2D image representation, a data rate frequency for the quilted graphic 2D image representation, a bit depth for the quilted graphic 2D image representation, a number of channels for the quilted graphic 2D image representation, processing type for the quilted graphic 2D image representation, scan type for the quilted graphic 2D image representation, and encoding scheme for the quilted graphic 2D image representation.

5. The method as recited in claim 1, wherein the act of staging a two dimensional image comprises an act of staging a quilted graphic 2D image representation that includes one or more of: imagery data, audio data, video data, gaming data, financial data, trading data, broadcast data, radio data, digital book data, and geo-spatial data.

6. The method as recited in claim 1, wherein the act of streaming one or more series of encoded graphic representations along with content control data comprises an act of streaming video data from a video quilt along with a portion of content control data for the video data.

7. The method as recited in claim 1, wherein the act of streaming one or more series of encoded graphic representations along with content control data comprises an act of streaming audio data from an audio quilt along with a portion of content control data for the audio data, the audio quilt in the form of one of: a single channel audio image, an image quilt of a stereo paired audio signal, or an image quilt of three of more audio channels into audio data.

8. The method as recited in claim 1, wherein the act of streaming one or more series of encoded graphic representations along with content control data comprises an act of streaming one or more series of encoded graphic representations along with content control data using a protocol selected from among: User Datagram Protocol (“UDP”), Real-time Streaming Protocol (“RTSP”), Real-time Transport Protocol (“RTP”), the Real-time Transport Control Protocol (“RTCP”), the HyperText Transfer Protocol (“HTTP”) adaptive bitrate streaming, Transmission Control Protocol (“TCP”), Unicast protocols (“UP”), Multicast protocols, IP Multicast (“IPM”), Internet Group Management Protocol (“IGMP”), Protocol Independent Multicast (“PIM”), Peer-to-peer (“P2P”) protocol, File Transfer Protocol (“FTP”), Secure Shell Protocol (“SSH”), and Secure Copy Protocol (“SCP”).

9. The method as recited in claim 1, wherein the content control data is one or more of: digital rights management data, content access data, and geospatial tracking data.

10. At a computer system including one or more processors and system memory, the computer system connected to another computer system over a computer network, a computer-implemented method for streaming portions of a quilted image representation along with content control data, the method comprising:
an act of deducing conversion properties for a two dimensional image at the other computer system, the two dimensional image quilting together one or more encoded series of graphical representations quilted to represent the content of the one or more digital assets, the one or more encoded series of graphic representations contained within one or more rows and one or more columns of the two dimensional image, each of the one or more series of encoded graphic representations corresponding to a portion of the one or more digital assets, at least one of the one or more series of encoded graphic representations including a portion of content control data;
an act of processing a stream of one or more series of encoded graphic representations for content control, including for at least one series of encoded graphic representations in the stream of one or more series of encoded graphic representations:
an act of receiving a series of encoded graphic representations from the computer network, the series of encoded graphic representations included in the stream of series of encoded graphic representations, the series of encoded graphic representations including a portion of content control data;
an act of decoding the encoded series of graphic representations;
an act of accessing the portion of content control data from the series of encoded graphic representations; and
using the content control data to make a content control decision with respect to the one or more digital assets included in the two dimensional image.

11. The method as recited in claim 10, wherein the act of deducing conversion properties for a two dimensional image at the other computer system comprises an act of deducing a resolution for rendering a digital asset, the resolution selected from among a plurality of different resolutions for the digital asset quilted into the two dimensional image.

12. The method as recited in claim 11, wherein the act of deducing a resolution for rendering a digital asset comprises an act of deducing a resolution for rendering a digital asset, the digital asset selected from among; imagery data, audio data, video data, gaming data, broadcast data, financial data, trading data, radio data, digital book data, and geo-spatial data

13. The method as recited in claim 10, wherein the act of receiving a series of encoded graphic representations from the computer network comprises an act receiving a streaming digital asset using a per channel bit depth in a range from 2 bit to 64 bit.

14. The method as recited in claim 10, wherein the act of receiving a series of encoded graphic representations from the computer network comprises an act of receiving a series of encoded graphic representations streamed using a protocol selected from among: User Datagram Protocol (“UDP”), Real-time Streaming Protocol (“RTSP”), Real-time Transport Protocol (“RTP”), the Real-time Transport Control Protocol (“RTCP”), the HyperText Transfer Protocol (“HTTP”) adaptive bitrate streaming, Transmission Control Protocol (“TCP”), Unicast protocols (“UP”), Multicast protocols, IP Multicast (“IPM”), Internet Group Management Protocol (“IGMP”), Protocol Independent Multicast (“PIM”), Peer-to-peer (“P2P”) protocol, File Transfer Protocol (“FTP”), Secure Shell Protocol (“SSH”), and Secure Copy Protocol (“SCP”).

15. The method as recited in claim 10, wherein the act of using the content control data to make a content control decision with respect to the one or more digital assets included in the two dimensional image comprises an act of using at least one of: digital rights management data and content access data to authorize rendering a digital asset.

16. The method as recited in claim 15, wherein the act of using at least one of: digital rights management data and content access data to authorize rendering a digital asset comprises an act of making a content control decision authorizing the rendering of a digital asset at one of: a mobile phone and a tablet device.

17. The method as recited in claim 10, wherein the act of using the content control data to make a content control decision with respect to the one or more digital assets included in the two dimensional image comprises an act of using a geospatial tag to track a digital asset geospatially.

18. The method as recited in claim 1, wherein the content control data is one or more of: digital rights management data, content access data, and geospatial tracking data.

19. A system, the system comprising:
a computer network;
one or more computer systems; and
a server, the server comprising:
one or more processors;
system memory;
one or more computer-readable storage devices having stored there one computer-executable instructions representing an un-quilting module, the un-quilting module configured to:
stage a two dimensional image, the two dimensional image quilting together one or more encoded series of graphic representations quilted to represent the content of one or more digital assets, the one or more encoded series of graphic representations contained within one or more rows and one or more columns of two dimensional image, each of the one or more series of encoded graphic representations corresponding to a portion the one or more digital assets, at least one of the one or more series of encoded graphic representations including a portion of content control data;
deduce conversion properties for the two dimensional image; and
stream one or more series of encoded graphic representations along with content control data to the one or more computer systems, including for each series of encoded graphic representations in the one or more series of encoded graphic representations being streamed:
un-quilt a series of encoded graphic representations from a row and column of the two dimensional image; and
stream the series of encoded graphic representations, along with any included content control data, onto the network for delivery to the one or more computer systems.

20. The system as recited in claim 19, wherein each of the one or more computer systems comprises:
one or more processors;
system memory; and
one or more computer-readable storage devices having stored there one computer-executable instructions that, when executed, cause the computer system to:
deduce the conversion properties for the two dimensional image;
process the stream of one or more series of encoded graphic representations for content control, including for at least one series of encoded graphic representations in the stream of one or more series encoded graphic representations:
receive a series of encoded graphic representations from the computer network, the series of encoded graphic representations included in the stream of one or more series of encoded graphic representations, the series of encoded graphic representations including a portion of content control data;
decode the encoded series of graphic representations;
access the portion of content control data from the series of encoded graphic representations; and
use the content control data to make a content control decision with respect to the one or more digital assets included in the two dimensional image.

21. The computer system as recited in claim 20, wherein the content control data is one or more of: digital rights management data, content access data, and geospatial tracking data.
